(19) United States
(12) Patent Application Publication
(10) Pub. No.: US 2005/0002365 A1
(43) Pub. Date: Jan. 6, 2005

(54) Systems and methods for acknowledgement of multi-cast traffic

(76) Inventor: Shugong Xu, Camas, WA (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/892,277

(22) Filed: Jul. 14, 2004

Related U.S. Application Data
(63) Continuation of application No. PCT/US03/01696, filed on Jan. 21, 2003.
(60) Provisional application No. 60/319,094, filed on Jan. 22, 2002.

(51) Int. Cl. H04Q 7/24

(52) U.S. Cl. 370/338; 370/473; 714/748

(57) ABSTRACT

Embodiments of the present invention comprise methods and systems for MAC layer acknowledgement of the receipt of network data in a multicast transfer environment. Some embodiments include methods wherein data is sent from a source to a MAC layer multicast address followed by separate acknowledgement requests, which are sent to each data recipient's MAC layer unicast address. Each recipient may then acknowledge receipt of the multicast data thereby allowing the source to resend any lost data. The MAC layer acknowledgement of these embodiments allows fast quality of service assurance compatible with demanding audio and video applications where higher level acknowledgement is not effective.

### RELATED APPLICATIONS

This application is a continuation of International Application No. PCT/US03/01696, filed Jan. 21, 2003, entitled “SYSTEMS AND METHODS FOR ACKNOWLEDGMENT OF MULTI-CAST TRAFFIC,” invented by Shugong Xu, now published under International Publication No. WO 03/062955 A2; which claims the benefit of U.S. Provisional Patent Application No. 60/319,094, filed Jan. 22, 2002, entitled “METHODS AND SYSTEMS TO SUPPORT ACKNOWLEDGEMENT OF MULTI-CAST BASED ON BURST ACK,” invented by Shugong Xu and Srinivas Kandala.

### BACKGROUND OF THE INVENTION

Networks may be used to efficiently transfer information between networked devices, however the variety of data now transmitted on networks requires differing protocols and methods to provide optimum efficiency and reliability. Many data networks support a number of data transfer schemes including, but not limited to unicast, broadcast and multi-cast transfer.

During unicast transfer, data is sent from a single source to a single recipient. If multiple recipients must receive the same information, the information must be sent once for each recipient. When there are many recipients of a unicast message, a network can easily become overloaded and congested.

A broadcast transfer scheme sends data from a single source to all recipients on a network at the same time. This scheme avoids multiple transmission of identical data, but all stations on the network receive the data whether they need it or not. Devices not intended to receive the information must receive it and discard it. Multicast transfer provides a limited form of broadcast in which a subset of the stations on the network agree to listen to a given multicast address. The set of participating stations is called a multicast group. To join a multicast group, a station must instruct its host interface to accept the group's multicast address. The advantage of multicasting lies in the ability to limit broadcast: every station in a multicast group can be reached with a single packet transmission, but stations that choose not to participate in a particular multicast group do not receive packets sent to the group.

Due to the difficulty of acknowledging the multicast transmission from the multicast group back to the multicast originator, current layer two multicast schemes, such as IEEE 802.11, do not provide for multicast acknowledgement. In an unreliable network, such as wireless LAN, there is a significant risk that some of the participating stations will not receive all of the multicast packets correctly. Without layer 2 multicast acknowledgment, the sender of the multicast packets cannot retransmit the lost packets without a significant delay.

For traditional applications, this is not a big problem since those applications can reply on the upper layer (e.g. Transport layer) to provide acknowledgment and retransmission to improve reliability. However, for time-sensitive, ordered data, such as digital Audio/Video (A/V) data, serious problems may arise. For digital video and audio transmission, network packets must be received in a specific order and often decoding information must be received before actual data packets can be decoded. These order requirements impose time constraints on packet reception that cannot be handled through upper layer acknowledgement techniques.

Thus, an acknowledgment scheme in Layer 2 for multicast is extremely desirable for those time-critical AV applications.

### SUMMARY

Embodiments of the present invention comprise methods and systems for acknowledging the receipt of multicast network data within layer two of a network environment.

### BRIEF DESCRIPTION OF THE DRAWINGS

FIG. 1 is a diagram showing a typical network configuration for some embodiments of the present invention.

FIG. 2 is a flowchart showing steps performed to acknowledge data transmission in some embodiments of the present invention.

FIG. 3 is a flowchart showing steps performed by some embodiments of the present invention for acknowledgement of data transmission.

FIG. 4 is a diagram showing a typical network configuration for some embodiments of the present invention comprising an acknowledgement sub-group.

FIG. 5 is a flowchart showing steps performed in some embodiments of the present invention comprising acknowledgement sub-groups.

FIG. 6 is a flowchart showing steps performed in some embodiments of the present invention comprising acknowledgement sub-groups wherein individual member acknowledgements are expected before further acknowledgement requests are transmitted.

### DETAILED DESCRIPTION

Embodiments of the present invention may be implemented in conjunction with network environments that comply with the following standards as well as other environments. The following standards are hereby incorporated by reference:

ISO/IEC 8802-11 Information technology—Telecommunications and information exchange between systems—Local and metropolitan area networks-specific requirements-Part 11: Wireless LAN Medium Access Control (MAC) and Physical Layer (PHY) Specifications

ISO/IEC 8802-15 Information technology—Telecommunications and information exchange between systems—Local and metropolitan area networks-specific requirements-Part 15: Wireless Medium Access Control (MAC) and Physical Layer (PHY) specifications for Wireless Personal Area Networks

802.11e-D4.0 Draft of 802.11e: Medium Access Control (MAC) Enhancements for Quality of Service (QoS), Nov 2002

Current implementations of networking technology do not acknowledge multicast data frame transmission within layer two (MAC layer) of the network environment. However, high-quality audiovisual (AV) applications in Wireless Local Area Networks (WLAN) demand a faster acknowledgement service that can operate within layer two of the network environment.

Embodiments of the present invention comprise acknowledgement methods and apparatus for multicast service in packet-based networks. Some embodiments of the present invention are particularly adaptable to implementations of IEEE 802.11(e) networks, which comprise a GroupACK (GA) feature (prior attempts at this feature were previously known as Burst ACK). However, other network configurations, such as IEEE 802.15(a) Ultra-Wide Band networks, some power-line networks and other network configurations may also be used to implement embodiments of the present invention.

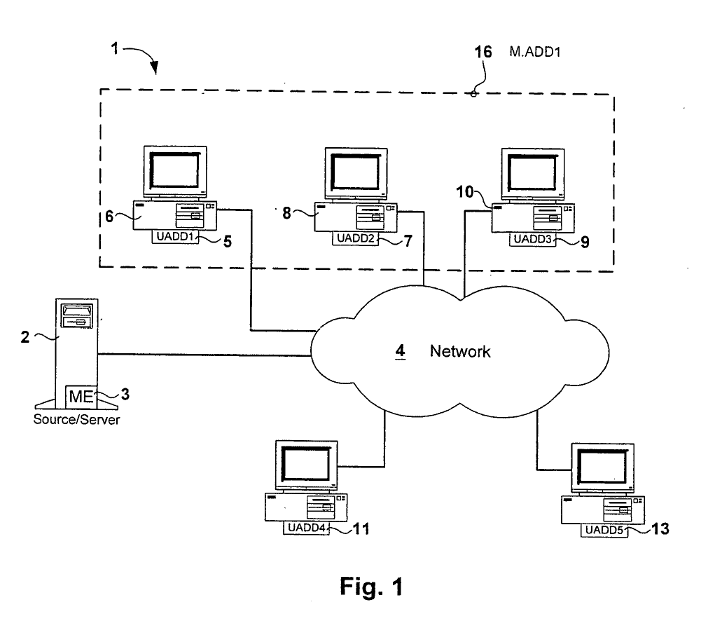

Some embodiments of the present invention may be explained in reference to FIG. 1, wherein a typical network environment 1 of embodiments of the present invention is shown. In these embodiments, a network source or server 2 may transmit information over a network 4 to multiple recipient stations 6, 8, 10, 12 & 14. A management entity 3, which may be a part of source 2, may be used to manage addresses and network functions. Each recipient station 6,8,10,12 &14 has a Medium Access Control (MAC) layer unicast address 5, 7, 9, 11 & 13 (U.ADD) as part of typical hardware and network configuration. When a multicast group is formed, a single multicast address 16 (M.ADD) is correlated by the individual group members 6, 8 & 10.

In this manner, a single multicast transmission can be directed to multiple station recipients without rebroadcasting to each recipient. However, when using demanding applications in unreliable, lossy networks, a quick and effective acknowledgement of the multicast transmission is useful. In many network configurations, a multicast sender 2 may not simply request acknowledgement thorough the layer two (MAC layer) multicast mechanism. This would cause all recipients to respond with an acknowledgement at the same time and all acknowledgements would not easily be received by the sender 2 in a timely manner.

After transmitting a quantity of information (i.e., one or more packets), embodiments of the present invention may send a separate Group Acknowledgement Request (GAR) to each MAC layer unicast address 5,7 & 9 of members of the multicast group 16. Methods related to how the multicast sender 2 obtains and maintains these unicast addresses will be discussed in a later part of this document.

In response to the individual GARs, each station 6, 8 &10 in the multicast group 16 will respond with a Group Acknowledgement (GA) wherein each station 6, 8 & 10 indicates which packets in the multicast transmission were received and which packets were lost. With this packet loss information, the source/server 2 may rebroadcast lost packets to the multicast group in time for demanding AV and multimedia applications.

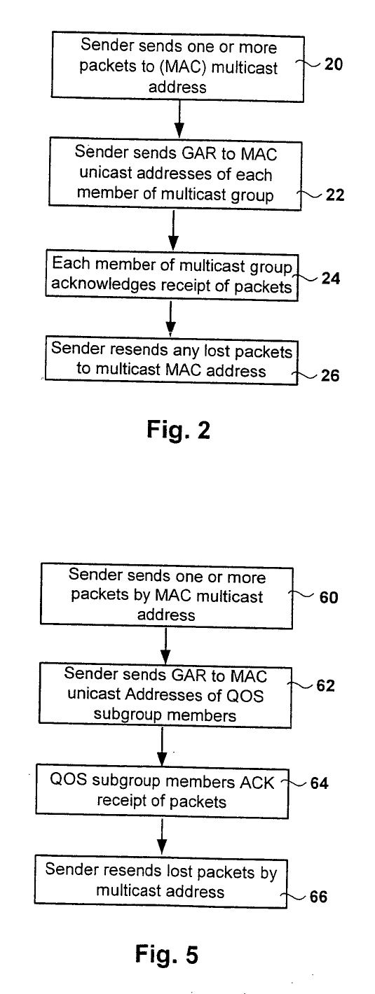

Embodiments of the present invention may be further explained in reference to FIG. 2, which designates several steps of embodiment methods. As explained above, the process may begin with a MAC layer multicast transmission 20 from a network source 2. The multicast transmission is distributed to each member of the multicast group according to the particular network protocols and management methods. After a designated portion of the multicast transmission has been sent, the sender sends 22 an individual GAR to the MAC layer unicast addresses of each member of the multicast group.

Each member of the group responds 24 to the GAR with a GA, which acknowledges receipt of packets in the multicast transmission. When one or more of the GAs have been received, the sender may resend 26 any packets that were lost during the first multicast transmission. This process may be repeated until all data has been transmitted along with retransmission of any lost packets.

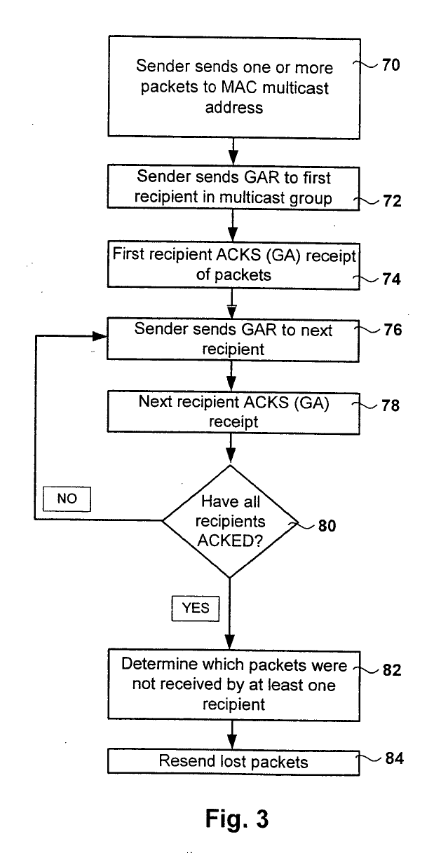

In some embodiments of the present invention, as illustrated in FIG. 3, a sender 2 may send 70 one or more packets of data to a MAC layer multicast address. Following this transmission, the multicast sender 2 may send one GAR 72 to one member of the multicast group and then wait for the GA 74 from that member. After receiving the GA from a first member, the sender may request 76 and receive 78 acknowledgment from another member by sending a GAR to its unicast address. This process may be repeated 80 until the sender has requested acknowledgment from all the members. If the sender failed to receive an expected GA after sending out a GAR, the sender may choose to resend the GAR to this particular member immediately, or move on to the next member on the list for the acknowledgment process and get back to the failed one after other members have successfully responded to the GAR.

Once all members have acknowledged receipt of the data, the acknowledgements may be evaluated to determine which packets were not correctly received by at least one member 82. These lost packets may be resent 84 to multicast address without any further delay.

The unicast addresses of the members in the multicast group may be sent to and maintained by the multicast sender 2. The multicast sender may be informed of the unicast addresses of the intended participating stations through Layer 2 signaling, or through higher layer signaling. Address data may be maintained by the management entity of the sender station.

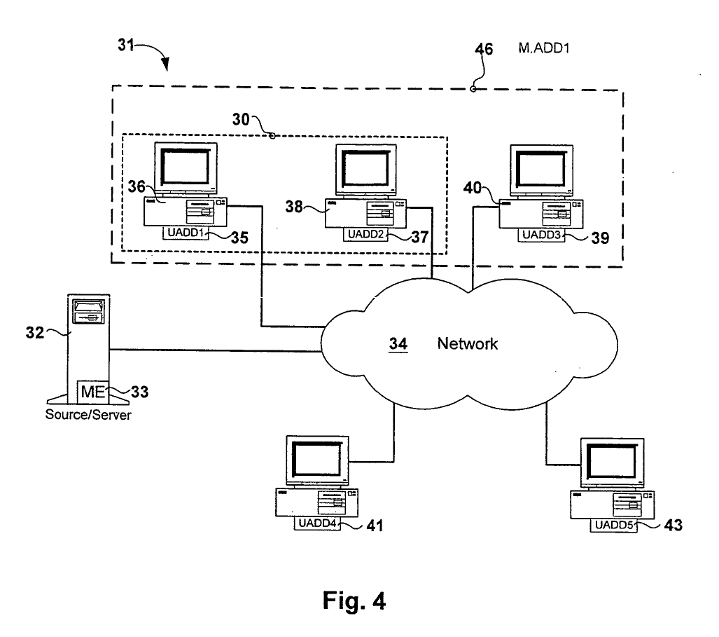

In some embodiments of the present invention, described in reference to FIG. 4, sub-groups may be used to establish a quality of service within a multicast group. These embodiments comprise a network environment 31 in which a source or server 32 may transmit information over a network 34 to multiple recipient stations 36, 38, 40, 42 & 44. The management entity 33, which is a part of source 32, may be used to manage addresses and network functions. Each recipient station 36,38,40,42 & 44 has a Medium Access Control (MAC) layer unicast address 35, 37, 39, 41 & 43 (U.ADD) as part of typical network configuration. When a multicast group is formed, a single multicast address 46 (M.ADD) is correlated by the individual group members 36, 38 & 40. In these embodiments, a subgroup 30 of the multicast group 46 may be maintained through a MAC layer acknowledgement service.

In these embodiments, a sender 32 may transmit one or more packets of data to a MAC layer multicast address 46 thereby attempting to deliver data to all recipients 36, 38 and 40 within the multicast group 46. Some members of multicast group 46 may require a reliable service that is higher than other members of the group. These members may become part of an acknowledgment or QOS sub-group for which MAC layer acknowledgement is implemented. In this case, once a sender 32 has sent one or more packets of data, sender 32 may send a Group Acknowledgement Request to the MAC layer unicast addresses 35 & 37 of each member of the acknowledgment sub-group 30. Each acknowledgment sub-group member 36 & 38 may then respond to the GAR with a Group Acknowledgement indicating which packets have been received by each member 36 & 38. A sender 32 may then determine whether packets have been lost and resend any lost packets to the multicast group 46.

The steps performed by embodiments of the present invention using an acknowledgment sub-group for multicast may be explained in reference to FIG. 5. In these embodiments, a sender transmits 60 one or more packets to a MAC layer multicast address. A sender may then send an individual Group Acknowledgement Request (GAR) 62 to the MAC layer unicast address of each member of an acknowledgment sub-group comprising one or more recipients of the initial multicast transmission. Each member of the acknowledgment sub-group may respond 64 to the GAR with a Group Acknowledgement (GA) indicating whether any packets have been lost. If packets have been lost, the sender 32 may retransmit 66 the lost packets to the members of the multicast group.

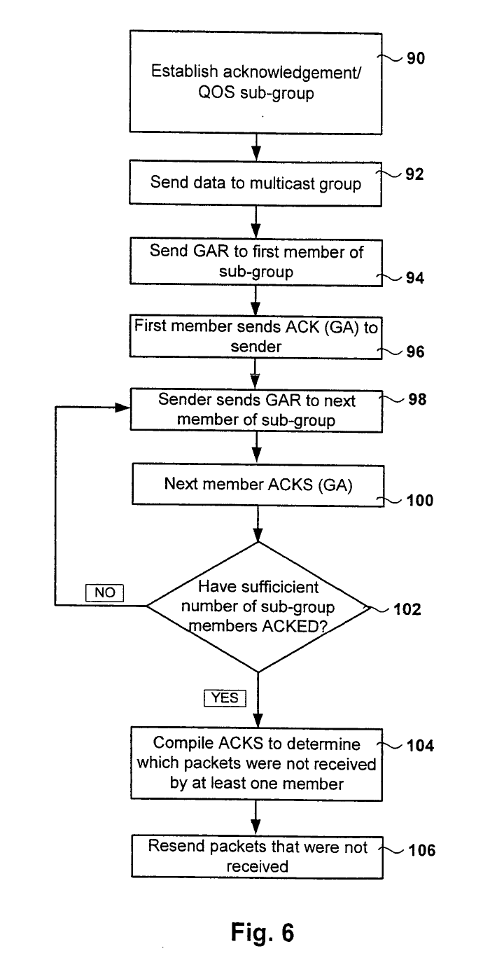

In some embodiments of the present invention, as described with reference to FIG. 6, an acknowledgement or QOS sub-group may be established 90 at any point prior to data transmission. Data may then be sent to a MAC layer multicast address 92. The multicast sender may then send an individual GAR to a first member 94 of the acknowledgment sub-group 30 and then wait for the GA 96 from that member. After receiving the GA from this first member, the sender may request 98 and receive 100 acknowledgment from another member on the list by sending a GAR to its unicast address. This process may be repeated 102 until the sender has requested and received acknowledgment from all members. If the sender fails to receive an expected GA after sending out a GAR, the sender may choose to resend the GAR to this particular member or move on to the next member on the list for the acknowledgment process and get back to the failed one after all other members on the acknowledgment sub-group list have successfully responded to the GAR.

Once a sufficient number of sub-group members have acknowledged, the acknowledgements may be evaluated 104 to determine which packets were not properly received by at least one station in the sub-group. These lost packets may be resent 106 to the sub-group without further delay.

The unicast addresses of the members in the acknowledgment sub-group of the multicast group may be obtained and maintained by the multicast sender. Sub-group addresses and other data may be communicated through Layer 2 signaling, or through higher layer signaling. This communication may be managed through the management entity of the sender station. In these embodiments, the sender will need to maintain a list of the unicast addresses for the acknowledgment sub-group. However, in these embodiments, the sender does not need to maintain the list of unicast addresses for the whole multicast group.

Some embodiments of the present invention may comprise sub-group management methods and systems. In these embodiments, a multicast member may inform a sender of its interest in joining an acknowledgement or QOS sub-group within a multicast group. This may be done through upper layer signaling or by other methods. In response to this request, the multicast sender may add the unicast address of the member to a sub-group list maintained by the sender.

Members of a sub-group may also be eliminated from the group under certain conditions. If a sub-group member fails to reply after a certain time period or certain number of tries, that member's unicast address may be removed from the sub-group list.

Other variations and embodiments of the invention will occur to those skilled in the art.

1. A method for acknowledging the receipt of time-sensitive multicast data within the MAC layer of a network, said method comprising:
a. sending data over a network from a source to a plurality of recipients using a MAC layer multicast address;
b. sending separate acknowledgement requests to each of said plurality of recipients using each recipient's MAC layer unicast address; and
c. receiving an acknowledgement from at least one of said recipients, said acknowledgement comprising an indication of which portions of said data were not received.

2. A method as described in claim 1, wherein said network is an IEEE 802.11 (e) compliant network and said separate acknowledgement requests are Group Acknowledgement Requests.

3. A method as described in claim 1, wherein said network is an IEEE 802.11 (e) compliant network and said acknowledgements are Group Acknowledgements.

4. A method as described in claim 1, further comprising resending from said source to said MAC layer multicast address any of said data that was not received.

5. A method as described in claim 1, wherein said acknowledgments are evaluated to determine what part of said data was not correctly received by at least one of said recipients.

6. A method for transmitting time-sensitive data over a wireless network using a multicast transmission, said method comprising:
a. sending data over a network from a source to a plurality of recipients using a MAC layer multicast address, said data comprising at least one packet of data;
b. establishing an acknowledgement sub-group with sub-group members comprising at least one of said recipients;
c. sending separate Group Acknowledgement Requests to each of said sub-group members using each member's MAC layer unicast address;
d. receiving Group Acknowledgements from at least one of said sub-group members, said Group Acknowledgements comprising an indication of whether any of said data was not received; and
e. resending from said source to said recipients any packets that were not received.

7. A method as described in claim 6, said method further comprising evaluating at least one of said Group Acknowledgements from at least one of said sub-group members to determine whether any of said data was not received by at least one member of said sub-group and wherein said resending comprises resending only those packets that were not received.

8. A system for transmitting acknowledged data over a wireless network using a multicast transmission, said system comprising:
a. a data source for sending data over a network from said source to a plurality of recipients using a MAC layer multicast address, said data comprising at least one packet;
b. a sender for sending separate acknowledgement requests to each of said plurality of recipients using each recipient's MAC layer unicast address;
c. a receiver for receiving acknowledgements from at least one of said recipients, said acknowledgements comprising an indication of which packets of said data were not received;
d. an evaluator for evaluating said acknowledgments to determine which of said at least one packet were not correctly received by at least one of said recipients; and
e. wherein said source resends from said source to said recipients any packets that were not correctly received.

9. A system for receiving acknowledged data over a wireless network using a multicast transmission, said system comprising:
a. at least one recipient station for receiving a group of packets from a source over a network using a MAC layer multicast address;
b. wherein said at least one recipient station also receives a separate acknowledgement request from said source using said at least one recipient's MAC layer unicast address;
c. wherein said at least one recipient station also sends an acknowledgement to said source, said acknowledgement comprising an indication of which packets of said data were not received;
d. wherein said source compiles all the received acknowledgments to determine whether any of said packets were not correctly received by any of said at least one recipient; and
e. wherein said at least one recipient station also receives from said source a retransmission of any packets that were not acknowledged as received in said acknowledgement.
